(19) United States
(12) Patent Application Publication
(10) Pub. No.: US 2005/0198411 A1
(43) Pub. Date: Sep. 8, 2005

(54) Commingled write cache in dual input/output adapter

(75) Inventors: Brian Eric Bakke, Rochester, MN (US); Robert Edward Galbraith, Rochester, MN (US); Brian James King, Rochester, MN (US); Timothy Jerry Schimke, Stewartville, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/793,525

(22) Filed: Mar. 4, 2004

(51) Int. Cl. G06F 13/00

(52) U.S. Cl. 710/22; 711/162; 711/118

(57) ABSTRACT

An apparatus, program product and method maintain data coherency between paired I/O adapters by commingling primary and backup data within the respective write caches of the I/O adapters. Such commingling allows the data to be dynamically allocated in a common pool without regard to dedicated primary and backup regions. As such, primary and backup data may be maintained within the cache of a secondary adapter at a different relative location(s) than is the corresponding data stored in the cache of the primary adapter. In any case, however, the same data is updated in both respective write caches such that data coherence is maintained.

### FIELD OF THE INVENTION

The invention generally relates to computer systems, and in particular, to Input/Output adapters used to store data in such systems.

### BACKGROUND OF THE INVENTION

Most businesses rely on computer systems to store, process and display information that is constantly subject to change. Unfortunately, computers on occasion lose their ability to function properly during a failure or sequence of failures leading to a crash. Computer failures have numerous causes, such as power loss, component damage or disconnect, software failure, or interrupt conflict. Such computer failures can be very costly to a business. In many instances, the success or failure of important transactions turn on the availability of accurate and current information. For example, the viability of a shipping company can depend in large part on its computers' ability to track inventory and orders. Banking regulations and practices require money venders to take steps to ensure the accuracy and protection of their computer data. Accordingly, businesses worldwide recognize the commercial value of their data and seek reliable, cost-effective ways to protect the information stored on their computer systems.

One practice used to protect critical data involves data mirroring. Specifically, the memory of a backup computer system is made to mirror the memory of a primary computer system. That is, the same updates made to the data on the primary system are made to the backup system. For instance, write input/output (I/O) requests executed in the memory of the primary computer system are also transmitted to the backup computer system for execution in the backup memory. Under ideal circumstances, and in the event that the primary computer system crashes, the user becomes connected to the backup computer system through the network and continues operation at the same point using the backup computer data. Thus, the user can theoretically access the same files through the backup computer system on the backup memory as the user could previously access in the primary system.

Clustering facilitates data mirroring and continuous availability. Clustered systems include computers, or nodes, that are networked together to cooperatively perform computer tasks. A primary computer of the clustered system has connectivity with a resource, such as a disk, tape or other storage unit, a printer or other imaging device, or another type of switchable hardware component or system. Clustering is often used to increase overall performance, since multiple nodes can process in parallel a larger number of tasks or other data updates than a single computer otherwise could.

I/O storage adapters are interfaces that handle such updates between a computing system and a storage subsystem. In a high availability configuration, such as a cluster, redundant I/O adapters further provide needed reliability. That is, in the event that a primary adapter fails, the backup adapter can takeover to enable continued operation. When employing storage adapters that have resident write caches, the write cache data and directory information, which pertains to the organization of the stored data, must be synchronized. Namely, the cache data and directory information in the primary and backup adapters must mirror each other, to ensure a flawless takeover in the event of a failure in the primary adapter.

Conventional I/O adapters include dedicated primary and backup memory regions for storing write cache data and directory information. That is, a conventional adapter stores primary cache data within a portion of memory that is exclusively available for primary data, and backup data within another fixed portion dedicated to backup data. This fixed allocation of memory provides for a relatively simple implementation, but fails to reflect differences in the relative workloads of the two adapters. As a result of this static division of resources between adapters, conventional adapters and host systems can suffer sub-optimal performance and resource utilization. For instance, the work applied to one adapter may exceed the memory requirements of its dedicated primary region, resulting in un-cached data, even though the memory of the backup region remains underutilized. Such problems become exacerbated in a clustered environment, where the increased number of I/O requests places a larger burden on the system to efficiently and accurately backup data.

In part because of such increased computing demands, a significant need exists in the art for an improved method and system for maintaining data coherency between two clustered adapters.

### SUMMARY OF THE INVENTION

The invention addresses these and other problems associated with the prior art by providing an apparatus, program product and method for efficiently and reliably mirroring write cache data between two clustered input/output (I/O) adapters. In one respect, processes consistent with the invention provide a system and associated processes for maintaining data coherency within a primary I/O adapter that is paired to a secondary, or backup, I/O adapter. More particularly, primary data is commingled along with backup data within a write cache of the primary I/O adapter. Corresponding primary and backup data may similarly be commingled in the secondary I/O adapter.

Put another way, newly received data from an I/O request is commingled with a pool of other data stored in the respective write caches of each adapter. By doing so, data may be dynamically allocated in at least one common pool of each I/O adapter. Such storage typically may be accomplished without regard to conventional dedicated primary and backup regions, or static storage spaces. That is, there may not be a definitive, logical region or other construct separating primary and backup data. Instead, a cache directory of the write cache may retrievably map, or otherwise organize and record where primary and backup data is stored within the data cache of each write cache.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter in which there is described exemplary embodiments of the invention.

### BRIEF DESCRIPTION OF THE DRAWINGS

FIG. 1 is a block diagram of a clustered computer system consistent with the invention.

FIG. 2 is a block diagram including dual input/output adapters of the computer system of FIG. 2.

FIG. 3 is a flowchart having sequenced steps for executing a read I/O request within the system of FIG. 3.

FIG. 4 shows a flowchart having steps for executing a write I/O request by the primary and secondary adapters of the system in FIG. 3.

FIG. 5 is a flowchart having steps for executing a de-staging operation by the primary and secondary adapters of FIG. 3.

FIG. 6 is a flowchart having steps for synchronizing the primary and secondary adapters of FIG. 3.

### DETAILED DESCRIPTION

The present invention discloses a novel method for maintaining data coherency between a primary adapter and its secondary, or backup, adapter. The primary and secondary adapters of the present invention provide mutual backup of their respective write caches for one another. Furthermore, the write cache storage of each of the adapters is dynamically pooled with respect to both primary and backup data to meet functional or performance requirements.

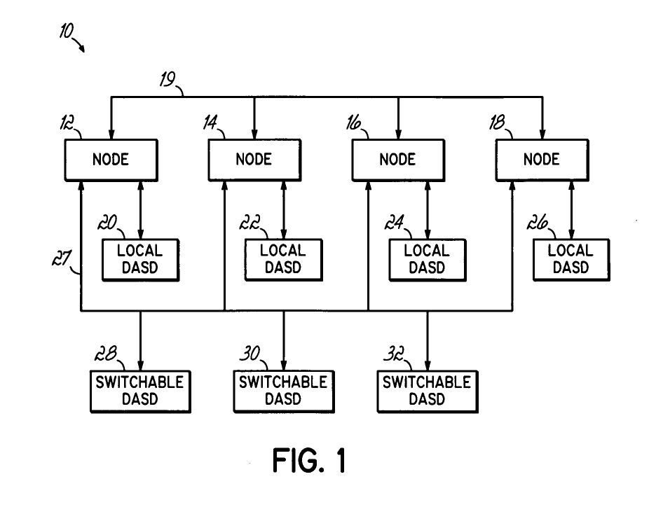

Turning now to the Drawings, wherein like numbers denote like parts throughout several views, FIG. 1 illustrates an exemplary clustered computer system 10 configured to maintain data coherency between first and second input/output (I/O) adapters. Namely, the system 10 includes nodes 12, 14, 16 and 18, as may comprise conventional personal computers or workstations. As such, the terms “node,” “system” and “computer” are sometimes used interchangeably throughout this specification. In any case, it should be appreciated that the invention may be implemented in multiple types of computers and data processing systems, e.g., in stand-alone or single-user computers such as workstations, desktop computers, portable computers, and the like, or in other programmable electronic devices (e.g., incorporating embedded controllers and the like).

The nodes 12, 14, 16 and 18 are coupled together using a system interconnection 19 that provides a communication link between the nodes 12, 14, 16 and 18. Communication link 19 may include any one of several conventional network connection topologies, such as Ethernet. Also depicted in the illustrative embodiment are local data storage devices 20, 22, 24 and 26, e.g., conventional hard disk drives, each of which is associated with a corresponding processing unit.

The nodes 12, 14, 16 and 18 may also couple via an I/O interconnect 27, such as Fibre Channel, to a plurality of switchable direct access storage devices (DASD's) 28, 30 and 32. Each of the switchable DASD's 28, 30 and 32 may include a redundant array of independent disks (RAID) storage subsystem, or alternatively, a single storage device. The switchable DASD's 28, 30 and 32 allow data processing system 10 to incur a primary system, e.g., first node 12, failure and still be able to continue running on a backup system, e.g., second node 14, without having to replicate or duplicate DASD data during normal run-time. The switchable DASD is automatically switched, i.e., no movement of cables required, from the failed system to the backup system as part of an automatic or manual failover.

Individual nodes 12, 14, 16 and 18 may be physically located in close proximity with other nodes, or computers, or may be geographically separated from other nodes, e.g., over a wide area network (WAN), as is well known in the art. In the context of the clustered computer system 10, at least some computer tasks are performed cooperatively by multiple nodes executing cooperative computer processes (referred to herein as “jobs”) that are capable of communicating with one another using cluster infrastructure software. Jobs need not necessarily operate on a common task, but are typically capable of communicating with one another during execution. In the illustrated embodiments, jobs communicate with one another through the use of ordered messages. A portion of such messages are referred to herein as requests, or update requests. Such a request typically comprises a data string that includes header data containing address and identifying data, as well as data packets.

Any number of network topologies commonly utilized in clustered computer systems may be used in a manner that is consistent with the invention. That is, while FIG. 1 shows a clustered computer system 10, one skilled in the art will appreciate that the underlying principles of the present invention apply to computer systems other than the illustrated system 10. It will be further appreciated that nomenclature other than that specifically used herein to describe the handling of computer tasks by a clustered computer system using cluster infrastructure software may be used in other environments. Therefore, the invention should not be limited to the particular nomenclature used herein, e.g., as to protocols, requests, members, groups, messages, jobs, etc.

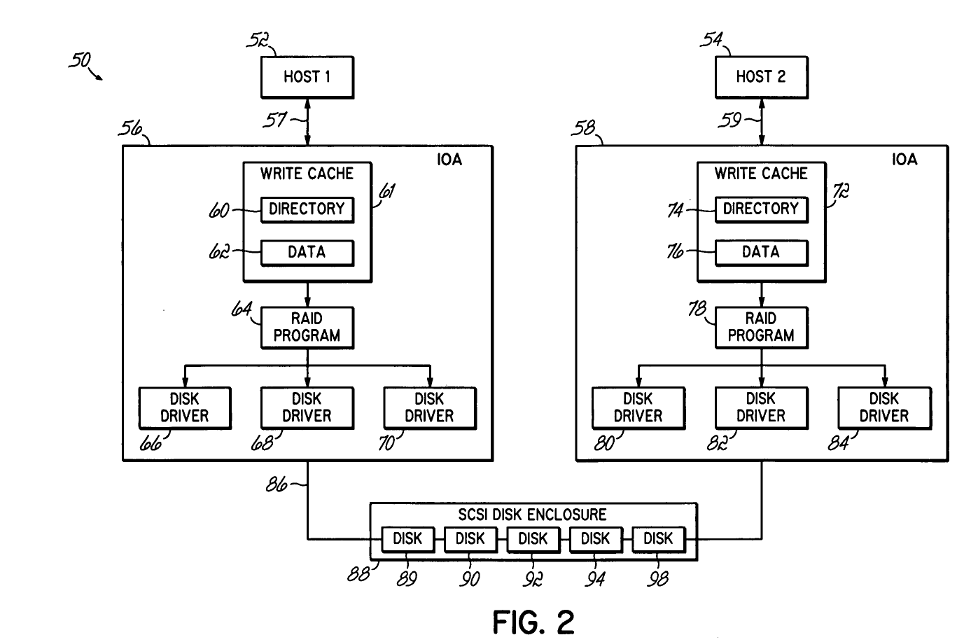

Referring now to FIG. 2, there is shown a block diagram of an exemplary computer system 50 that includes two host computers 52, 54 in communication with respective I/O adapters 56, 58. The I/O adapters 56, 58 may comprise a dual storage adapter, and/or a switchable DASD analogous to the DASD 28 of FIG. 1. The I/O adapters 56, 58 may be physically distinct and remotely located from each other. As shown in FIG. 2, the host computers 52, 54 communicate with the I/O adapters 56, 58 via communication links 57 and 59. Such links may include Peripheral Component Interconnect (PCI) buses, for instance.

Adapters cache I/O update requests prior to committing them out to disk. Committing these cached I/O request out to aisle is called destaging. Each I/O adapter 56, 58 includes a respective write cache 61, 72. A write cache receives and processes requests to manage adapter write cache data. To this end, each write cache 61, 72 includes a cache directory 60, 74. A write cache directory 60, 74 maintains information pertaining to the organization and storage of respective data cache 62, 76. Such data 62, 76 comprises I/O request data received from either or both host computers 52, 54. For instance, the data 62 maintained in the write cache 61 of a first I/O adapter 56 may include primary data from host computer 52, as well as backup data from host computer 54.

Conversely, data 76 of a second adapter 58 may include its own primary data from host 54, as well as backup data from primary adapter 56 and host computer 52. For explanatory purposes in the context of FIG. 2, the first adapter 56 is referred to as being a primary adapter, and adapter 58 is a secondary, or backup adapter. However, one skilled in the art will appreciate that this nomenclature is arbitrary in that at any given time, both or either adapter may function concurrently as a primary and/or a secondary adapter.

Each write cache 61, 72 of the adapters 56 and 58 communicates with a respective RAID program 64, 78. The RAID programs 64, 78 are configured to initiate the distribution of data across multiple disk drivers. As such, each I/O adapter 56, 58 also includes respective disk drivers 66, 68, 70, 80, 82, and 84. A disk driver is a logic component configured to communicate information over link 86 to storage disks 89, 90, 92, 94, 96, and 98. Link 86 may include a Small Computer System Interface (SCSI) bus, for instance, and disks 89, 90, 92, 94, 96, and 98 may be contained within a SCSI disk enclosure 88. Though not expressly shown in the block diagram of FIG. 2, one skilled in the art will appreciate that each write cache 61 and 72 may include access to a controller for processing requests and data.

Though not expressly shown in the block diagram of FIG. 2, one skilled in the art will appreciate that a dedicated hardware communication link may couple the I/O adapters 56 and 58 together. For instance, a link comprising a high speed serial bus may facilitate keeping the respective write cache directory 60 and data 62 mirrored between the I/O adapter 56 and the corresponding cache directory 74 and cache data 76 of the second I/O adapter 58. The dedicated communication link may couple to a message passing circuit that provides I/O adapter 56 the ability to send and receive data from the second adapter 58.

The general configuration of adapters in the exemplary environment is well known to one of ordinary skill in the art. It will be appreciated, however, that the functionality or features described herein may be implemented in other layers of software in the write cache of each adapter, and that the functionality may be further allocated among other programs or processors in a clustered computer system. Moreover, the adapters 56 and 58 may belong to the same or separate computers and/or DASD, for instance. Therefore, the invention is not limited to the specific software implementation described herein.

The discussion hereinafter will focus on the specific routines utilized to mirror data in a manner consistent with the present invention. The routines executed to implement the embodiments of the invention, whether implemented as part of a write cache, an operating system, a specific application, component, program, object, module or sequence of instructions, will also be referred to herein as “computer programs,” “program code,” or simply “programs.” The computer programs typically comprise one or more instructions that are resident at various times in various memory and storage devices in a computer, and that, when read and executed by one or more processors in a computer, cause that computer to perform the steps necessary to execute steps or elements embodying the various aspects of the invention.

Moreover, while the invention has and hereinafter will be described in the context of fully functioning computers, adapters and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and nonvolatile memory devices, floppy and other removable disks, hard disk drives, optical disks (e.g., CD-ROM's, DVD's, etc.), among others, and transmission type media such as digital and analog communication links.

It will be appreciated that various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Moreover, those skilled in the art will recognize that the exemplary environments illustrated in FIGS. 1 and 2 are not intended to limit the present invention. Indeed, those skilled in the art will recognize that other alternative hardware and/or software environments may be used without departing from the scope of the invention.

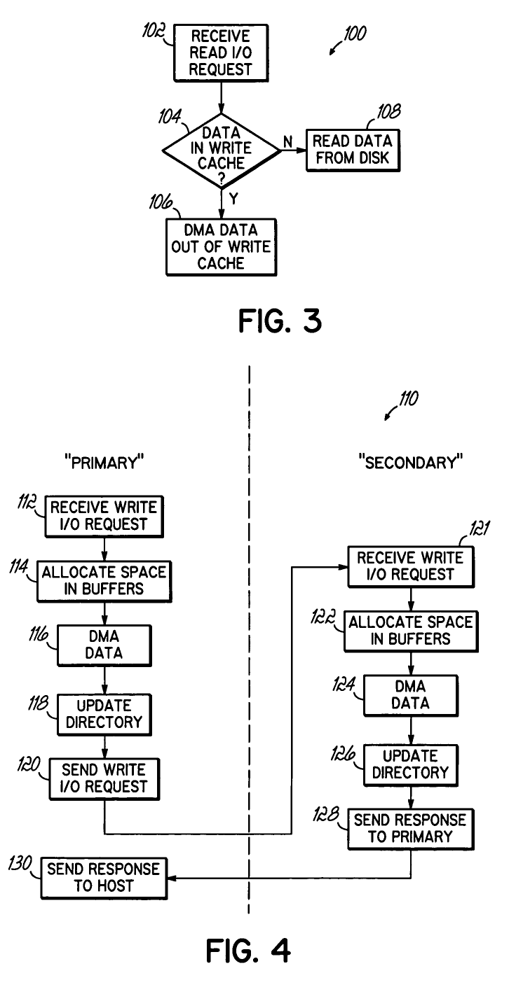

The flowchart 100 of FIG. 3 shows a sequence of exemplary steps for executing a read I/O request. The processes of the flowchart 100 may be executed by a write cache 61 of an I/O adapter 56, such as shown in FIG. 2. At block 102 of FIG. 3, the I/O adapter 56 receives a read I/O request from host system 52. A read I/O request typically is an instruction indicating a need to receive a block of data stored on a particular device. In response to receiving the request at block 102, the write cache 61 of the I/O adapter 56 may initially determine at block 104 whether data indicated by the request is present in the data cache 62. Such scenario may occur where the requested data has been previously cached in the write cache 61, but has not yet been de-staged, or committed out to disk 90 from the data cache 62.

If the write cache 61 determines that the data is present in the data cache 62 at block 104, then the write cache 61 initiates a Direct Memory Access (DMA) operation to read the applicable data from the data cache 62 at block 106 of FIG. 3. Such a feature helps ensure that the most current data is retrieved, as the cached data is typically more up to date than would be data already stored on a disk. Where the requested data is alternatively not in the write cache 61 at block 104, then the write cache 61 initiates reading the data from a disk 90 using the RAID program 64 and a disk driver 66, for instance. Of note, the data read from the disk may be cached in a separate read cache, for instance.

FIG. 4 is a flowchart 110 showing exemplary sequence steps suitable for execution by the primary and secondary I/O adapters 56, 58 of FIG. 2. More particularly, the flowchart 110 shows the respective actions taken by the I/O adapters 56, 58 when executing a write I/O request. At block 112 of FIG. 4, the write cache 61 of the primary I/O adapter 56 receives the write I/O request from host computer 52. In response to receiving the request, the write cache 61 of the primary adapter 56 allocates storage space in either or both the cache directory 60 and the data cache 62 at block 114.

Once the storage space has been freed at block 114, the write cache 61 initiates a DMA operation at block 116. That is, the data of the write I/O request is stored in data cache 62 of the write cache 61. The cache directory 60 is updated accordingly at block 118. For instance, organizational information pertaining to the storage of the data at block 116 is entered into the directory 60 at block 118. As such, the request has been received, stored and otherwise accounted for at block 118 by the write cache 61 of the primary I/O adapter 56.

The write cache 61 of the primary I/O adapter 56 then sends the write I/O request to the secondary I/O adapter 58 at block 120 of FIG. 4. After receiving the request at block 121, the write cache 72 of the secondary I/O adapter 58 allocates space within its own cache directory 74 and cache data 76 at block 122. Where necessary, the allocation of storage space may include flushing or otherwise freeing up unused data. The write cache 72 then initiates a DMA operation of the data at block 124 into the cache data 76. Of note, the new data from the request is commingled with a pool of other data stored in the cache data 76. As such, the data may be maintained within the cache 76 of the secondary adapter 58 at a different relative location(s) than is the corresponding data stored in the cache 62 of the primary adapter 56. In any case, however, the same data is updated in both caches 62 and 76 such that data coherence is maintained.

At block 126 of FIG. 4, the data stored within the cache directory 74 is updated to reflect the changes in the cache data 76 made at block 124. Directory data maintained within the cache directory 74 may also be commingled. That is, there may not be a definitive, logical region or other construct separating primary and backup data. Backup .data typically comprises data received from another adapter, while primary data generally regards data received directly from a host system.

When the DMA and update operations of blocks 124 and 126, respectively, are complete, the secondary I/O adapter 58 sends a response back to the primary I/O adapter 56 at block 128. A similar response at block 130 is sent from the primary I/O adapter 56 back to the host computer 52 at block 130 of FIG. 4. Where so configured, such responses may initiate further processes that may depend, in part, upon execution of the associated write I/O request.

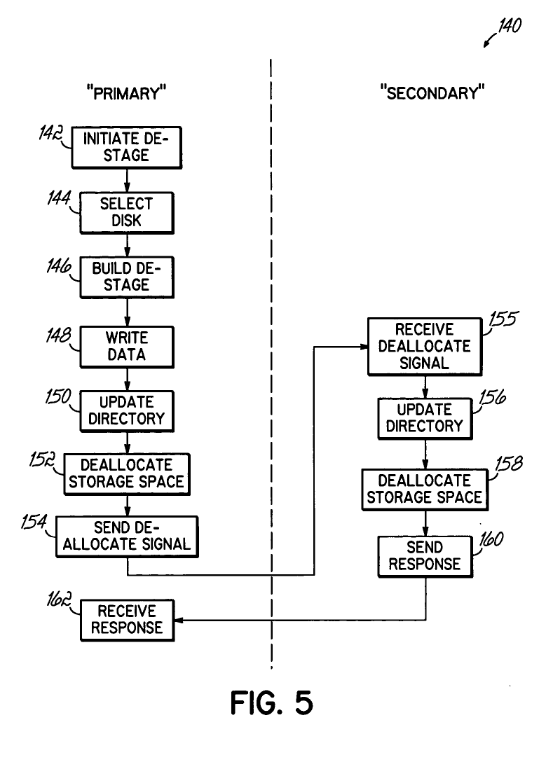

FIG. 5 is a flowchart 140 having steps executable by the primary and secondary I/O adapters 56 and 58, respectively, of FIG. 2 when performing a de-staging operation. De-staging includes writing data from the write cache 61 out to a disk 90. The flowchart 140 breaks out the respective steps taken by each of the primary and secondary I/O adapters 56 and 58 to show their interaction with each other.

Turning more particularly to the flowchart 140, the primary I/O adapter 56 may initiate a de-staging operation at block 142. An adapter 56 may initiate the de-staging operation in response to a predetermined occurrence. For instance, initiation processes of block 142 may include a request initiated by a write cache 61. Such a request may be generated in response to the write cache 61 determining that additional storage space is required in the data cache 62. As is discussed below in greater detail,.a de-staging operation initiated by such a request from the write cache 61 will free up memory space in the data cache 62 needed, for instance, for storing data of a newly arriving request. Another de-staging operation consistent with the invention may result from a timed occurrence generated by an internal clock. Such may be the case where it is desirable to periodically write out data to disk, for instance.

At block 144 of FIG. 5, the I/O adapter 56 may select a disk 90 to which data will be de-staged. The write cache 61 may accordingly build a de-stage operation at block 146 that includes information pertinent to the disk 90. For instance, a de-stage operation file may include formatting instructions particular to relevant data and routing information provided by the RAID program 64 and a disk driver 66. Accordingly, the data is written to the disk at block 148.

After the data is successfully written to the disk 90 at block 148, the write cache 61 of the primary I/O adapter 56 updates its cache directory 60 at block 150 of FIG. 5. As discussed above, data comprising the update is commingled, or interleaved, with other directory data. Other directory data may include both primary and backup derived data. Such commingling allows the data to be dynamically allocated in a common pool. Such storage may be accomplished without regard to dedicated primary and backup regions, or dedicated storage spaces. Though not shown in the flowchart 140, data in the cache directory 60 may also be de-allocated by the write cache 61 prior to the updating process at block 150. Such de-allocation may remove idle data, while making room for the new directory data.

The write cache 61 may subsequently or concurrently de-allocate storage space within the data cache 62 at block 152 of FIG. 5 in preparation of receiving future I/O request data. The primary I/O adapter 56 may then generate and send a de-allocation signal at block 154 to the secondary I/O adapter 58. The secondary I/O adapter 58 receives the de-allocation signal at block 155 and updates its own cache directory 74 at block 156 of FIG. 5. Of note, the data may be maintained within the directory 74 of the secondary adapter 58 at a different relative location(s) than is the corresponding data stored in the directory 60 of the primary adapter 56. In any case, however, the same data is updated in both cache directories 60 and 74 such that data coherence is maintained.

The write cache 72 of the secondary I/O adapter 58 may then de-allocate storage space at block 158 of FIG. 5 within its cache data 76. In this manner, unneeded data is purged to make additional storage space available within the adapter 58. A response is then sent at block 160 from the secondary I/O adapter 58 to the primary I/O adapter 56. That response is received at block 162 of FIG. 5. Subsequent processing may depend in part upon receipt of the response at block 162. For instance, a process dependent upon writing of the data to disk may wait until confirmation of the write and update is sent at block 160 prior to being executed.

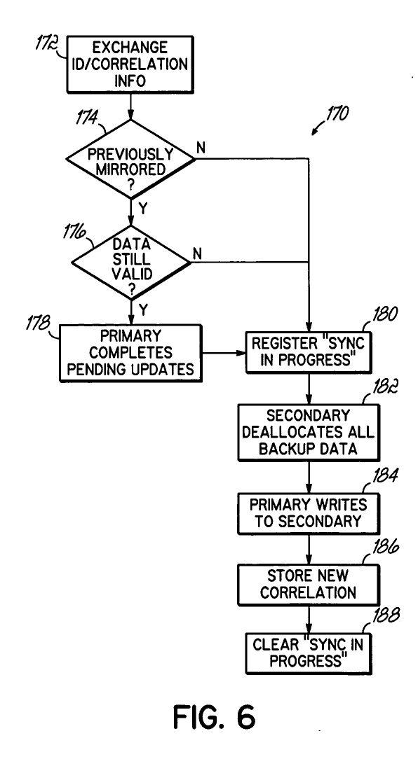

The flowchart 170 of FIG. 6 shows exemplary steps for synchronizing dual I/O adapters. Such synchronization processes may be necessary when two adapters are initially paired with each other at the beginning of a mirroring sequence. Synchronization processes may additionally be employed where data cohesion has been interrupted, such as by a failure or crash, and it is desirable to re-establish data cohesion, or mirroring, between the adapters.

Turning more particularly to the steps of the flowchart 170, the I/O adapters 56, 58 may exchange identification and correlation information at block 172. Identification information may include hardware, serial numbers or other data indicative of the location and/or identity of an adapter. Correlation information may include a sequence number or other data indicative of whether the adapters and/or devices have ever been paired before. As such, correlation data may include IOA to IOA Correlation Data (IICD) and IOA-Device Correlation Data (IDCD) as are known to those skilled in the art and as are explained in greater detail below. As will be clear after a full reading of the specification, whether the adapters have been previously paired may affect processes used to synchronize the adapters.

Namely, the system 50 uses the correlation information at block 174 of FIG. 6 to determine if two adapters previously mirrored each other's data. This determination may be performed by each adapter to determine if the data was previously mirrored in both or only one direction, e.g., from the a first adapter 56 to the second adapter 58, and/or from the second adapter 58 to the first adapter 56. That is, each adapter may determine independently if it is capable of serving as the backup for the other adapter. As such, the first adapter may serve as the backup for the second adapter, but the second adapter does not necessarily serve as a backup for the first. Typically an adapter will always be able to serve as a backup for the other adapter unless it already has valid backup write cache data for a different adapter.

Where it is determined at block 174 that the I/O adapters 56, 58 were formerly paired, then the system 50 at block 176 may determine if the data maintained within the respective write caches 61 and 72 of each adapter 56, 58 is still valid. For instance, it may be determined at block 176 that the data has not become corrupted. Such may be the case where two adapters were powered down and back up again at the same time. If so at block 178, the primary I/O adapter 56 may complete any pending updates at block 178 of FIG. 6.

Where the primary and secondary I/O adapters 56 and 58, respectively, have not previously mirrored each other and/or the data contained in the respective write caches 72 and 61 is no longer valid, the adapters 56, 58 may set a status indicator at block 180 comprising a synchronization in progress flag. Storage of such a status indicator may be useful should a failure occur during a synchronization process. For instance, the adapters 56, 58 will typically read such a status flag subsequent to the failure at block 172 when initially trying to resynchronize.

After setting the status indicator at block 180, the write cache 61 of the secondary I/O adapter 58 may de-allocate all backup data at block 182. The write cache 72 may identify all such backup data stored within the cache data 76 using information stored in the cache directory 74. The primary I/O adapter 56 then writes its data received from host 52 to the secondary I/O adapter 58. The process of writing such data to the adapter 58 is discussed in connection with the method steps of FIG. 4.

Either or both adapters 56, 58 will store at block 186 the new correlation information indicating that the adapters 56 and 58 have been paired. The adapters 56, 58 will then clear the synchronization in progress status flag at block 188 prior to a synchronization process completing.

In operation, an embodiment consistent with the invention creates a “logical mirror” of the cache data between adapters, as opposed to a “physical mirror.” All of the cache memory of a given adapter is treated as a common pool. This pool contains both primary cache data (for devices owned by this adapter) and secondary cache data (for devices owned by another adapter). Adapter firmware utilizes this pool of cache memory to create a “logical mirror” of the cache data held by the two adapters. Primary and backup cache data is interleaved in each adapter. The memory locations used in one adapter for a given piece of user data have no relationship to the memory locations used in the other adapter for that same user data.

When a write request is received by one adapter, it first places the write data into its cache memory by allocating local cache memory (for both the cache data and directory information), storing the data payload, and updating the directory. This adapter then mirrors the write data to a remote adapter by issuing a write request to the remote adapter. Upon receiving the request, the remote adapter will mirror the data into its memory by allocating local cache memory for both the cache data and directory information, storing the data payload, and updating the directory. To remove data from the cache, an adapter updates its local cache directory, frees the local data buffers back to the local pool, and sends an invalidate, or de-allocate, request to the remote adapter. When the remote adapter receives the invalidate request, it updates the local cache directory and frees the data buffers back to the local pool.

In this manner, resources, including the nonvolatile cache memory, are dynamically and continuously allocated between adapters. This allocation is based only upon current activity, is continuously variable as new requests are processed, and causes no disruptions or performance lags as allocations change between “primary” and “backup.” Moreover, all resources may be automatically used by a single adapter when no other adapter is present. Additionally, there is no need to move or relocate data when a standalone adapter is joined by a second adapter to form a redundant cluster. A number of conventional designs required the specific memory regions to be used for the “backup” data to be dedicated so this “backup” region had to be cleared via moving the data or writing it to disk prior to enabling the configuration. With an embodiment of the invention, there is no need for this action because “backup” data may be interspersed amongst the “primary” data. Devices can be moved between adapters as needed without the need to move or purge write cache data for that device. That is, redundancy may be enabled between asymmetric adapters because there is a “logical” mirror of data between adapters instead of a “physical mirror.”

Regarding another advantage enabled by an embodiment consistent with the invention, the adapters need not have the same level of resources, such as nonvolatile memory to store cache data, on each adapter. This is useful because it allows greater flexibility in that the design of new adapter in a system does not need to exactly match the design and resource capabilities of the other existing or replaced adapters in the system. The adapters will be able to work together in a clustered redundant adapter pair. This feature also allows a single adapter to be kept onsite as a temporary replacement for many other adapters with disparate characteristics, much like an automobile spare tire serves as a temporary replacement for a failed automobile tire until a new fully-capable replacement tire can be acquired and installed. Moreover, this advantageous feature removes the requirement to predetermine the distribution of resources between adapters, which simplifies setup and improves performance. This feature further simplifies processes needed to synchronize adapters and the process of switching devices between adapters.

In operation and during a write command with the aforementioned embodiment, local nonvolatile data buffers are allocated and the write data is written from the host into buffers. Then the nonvolatile cache directory on the primary adapter is updated to reflect the new data. Updating of the cache directory may also include freeing some nonvolatile data buffers if the write request partially or fully overlaid data that was already resident in the cache. Next a write request is sent from the primary adapter to the backup adapter for this device. The backup adapter receives the write command. The backup adapter allocates local nonvolatile data buffers. The write data is then retrieved from the primary adapter and placed into the buffers. Then the nonvolatile cache directory on the backup adapter is updated to reflect the new data. Updating of the cache directory may also include freeing up of some nonvolatile data buffers if the write request partially or fully overlaid data that was already resident in the cache. The backup adapter then responds back to the primary adapter with successful command completion, and the primary adapter can then respond to the host system with successful command completion.

During a de-stage operation, the primary adapter of the embodiment selects a disk it owns, and determines which data will be written. Then the data is written to the disk from the primary adapter. The primary adapter then updates its local nonvolatile cache directory, and frees the primary data buffers. An invalidate, or de-allocate, command is then sent from the adapter containing the backup cache data. The de-allocate command is the only communication required between adapters as part of this process, which results in relatively little additional overhead. Upon receipt of the de-allocate command, the backup adapter updates its local nonvolatile cache directory and frees the data buffers back to its local pool. A response is then sent to the primary adapter indicating that the de-allocate has been completed.

During a synchronization operation, two adapters exchange information about themselves to determine if synchronization is possible. For instance, each adapter can determine independently if it is capable of serving as the backup for the other adapter, and valid configurations exist that are asymmetric. That is, the first adapter may serve as the backup for the second adapter, but the second adapter does not serve as a backup for the first. Typically an adapter will always be able to serve as a backup for the other adapter unless it already has valid backup write cache data for a different adapter that is not present. In this case, mirroring of the write cache data to the adapter with valid backup data is precluded so that this data is not lost.

To exchange information, each adapter in the embodiment may send the other adapter identity information and an indication of whether or not the adapter has existing valid, primary write cache data. If such data exists, the IOA to IOA Correlation Data (IICD) for this primary data is also communicated. The adapters may also send an indication of whether or not they have existing valid, backup write cache data, and if so, then the IICD for this backup data is communicated. The adapters then do an independent comparison of the communicated data to decide if mirroring of the write cache data in either or both directions is to be established.

For each direction that mirroring is to be established, it is determined if the adapters were previously mirrored together in this direction, and if the mirrored data is still valid. This is true if the adapter receiving the mirrored data already has valid backup data from the primary adapter, and the IICD's of the primary and backup adapter match for this direction. If the mirrored data is already valid, then the primary adapter only needs to do a minimal amount of processing to begin normal operations. This processing consists solely of completing any operations (writes or invalidates) that were outstanding to the backup at the time the primary adapter was reset last. If the mirrored data is not already valid, then the adapter may store an indication of “synchronization in progress” for this direction in the nonvolatile configuration data in each adapter to indicate that they are not fully in synchronization yet. When all writes are completed, each adapter may store a new IICD to correlate the (now in sync) write cache data between primary and backup adapters. Each adapter may clear its indication of “synchronization in progress” for this direction, and normal operations now commence. Of note, no movement or flushing of write cache data to disk would be required to have the adapters become synchronized.

In operation and when an adapter fails as part of a mirrored configuration, the remaining adapter in the embodiment can continue to operate to maintain access to the disks it currently owns. However, the failed or missing adapter will no longer receive updates to the backup cache data. The configuration data may need to be consequently updated so that the backup data on the failed adapter is not erroneously viewed as valid when in reality it is stale (i.e. out of date). Two updates may be made to cover this condition. First, the IOA-Device Correlation Data (IDCD) may be updated on each device owned by the remaining adapter such that the backup write cache data stored in the missing adapter no longer is correlated with these devices. Second, the IICD connecting the remaining adapter's primary data and the missing adapter's backup data may be changed so that if the missing adapter reappears it will not erroneously believe the write cache data between adapters is coherent. The IICD connecting the remaining adapter's backup data and the missing adapter's primary data may not be changed since this data is not being updated and thus remains coherent. No nonvolatile write cache data will be moved as part of this process in the remaining adapter, and all resources not currently being used as backup data may be fully available for use by the adapter.

In operation and during a failover of a disk, the IDCD on both the adapter and the device may be changed to indicate data held by prior owning adapter is now stale. Normal operations begin to this device. The cache data that was previously backup becomes primary because of the updates-to the configuration data. The actual cache directory and cache data buffers do not need to be moved, copied, or updated. This device may now be treated just like any other device owned by this adapter.

While the present invention has been illustrated by a description of various embodiments and while these embodiments have been described in considerable detail, it is not the intention of the applicants to restrict, or in any way limit, the scope of the appended claims to such detail. For instance, any of the steps of the above exemplary flowcharts may be deleted, augmented, made to be concurrent with another, or be otherwise altered in accordance with the principles of the present invention.

Furthermore, while computer systems consistent with the principles of the present invention may include virtually any number of networked computers, and while communication between those computers in the context of the present invention may be facilitated by clustered configuration, one skilled in the art will nonetheless appreciate that the processes of the present invention may also apply to direct communication between only two systems as in the above example, or even to the internal processes of a single computer, or processing system. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

1. A method for maintaining data coherency within a primary input/output adapter paired to a secondary input/output adapter, wherein the primary input/output adapter includes a resident write cache, the method comprising commingling primary and backup data within a common data pool of the write cache of the input/output adapter.

2. The method of claim 1, wherein commingling the primary and backup data further includes de-allocating storage space in the pool of the write cache of the input/output adapter in response to detecting a de-staging occurrence.

3. The method of claim 2, wherein detecting the de-staging occurrence further includes detecting at least one occurrence selected from a group consisting of: a timed occurrence, a request initiated by the write cache and receipt an input/output request from a host system.

4. The method of claim 1, wherein commingling the primary and backup data further includes dynamically allocating storage space after receiving an input/output request at the input/output adapter from a host system.

5. The method of claim 1, wherein commingling the primary and backup data further includes updating at least one of a cache directory and a data cache of the write cache.

6. The method of claim 1, wherein commingling the primary and backup data further includes retrievably mapping the primary and backup data of the common data pool within a cache directory of the write cache.

7. The method of claim 1, wherein commingling the primary and backup data further includes sending a de-allocate signal to the secondary input/output adapter to update backup data at the secondary input/output adapter in response to a de-staging operation.

8. The method of claim 1, wherein commingling the primary and backup data further includes synchronizing the input/output adapter with the secondary input/output adapter using correlation data regarding at least one of a previously mirrored status and a synchronization in progress status.

9. The method of claim 1, wherein commingling the primary and backup data further includes allocating collective storage space for the primary and backup data within the write cache.

10. A method for maintaining data coherency within a dual input/output adapter system having primary and secondary adapters, wherein each of the primary and secondary adapters includes a resident write cache comprising data storage and directory components, the method comprising commingling primary and backup data within the respective write caches of the primary and secondary adapters.

11. The method of claim 10, wherein commingling primary and backup data within the respective write caches of the primary and secondary adapters further includes commingling data between adapters that include different memory capacities.

12. An input/output adapter comprising:
a write cache including a memory; and
program code configured to commingle primary and backup data associated with another input/output adapter within the memory of the write cache.

13. The input/output adapter of claim 12, wherein the write cache further includes at least one of a cache directory and a data cache.

14. The input/output adapter of claim 12, wherein the program code initiates de-allocating storage space in the pool of the write cache of the input/output adapter in response to detecting a de-staging occurrence.

15. The input/output adapter of claim 14, wherein the de-staging occurrence includes at least one event selected from a group consisting of: a timed occurrence, a request initiated by the write cache and receipt an input/output request from a host system.

16. The input/output adapter of claim 12, wherein the program code initiates receiving an input/output request at the input/output adapter from a host system.

17. The input/output adapter of claim 12, wherein the program code initiates updating at least one of a cache directory and a data cache of the write cache.

18. The input/output adapter of claim 12, wherein the program code initiates retrievably mapping the primary and backup data within a cache directory of the write cache.

19. The input/output adapter of claim 12, wherein the program code initiates sending a de-allocate signal to the secondary input/output adapter to update backup data at the secondary input/output adapter in response to a de-staging operation.

20. The input/output adapter of claim 12, wherein the program code initiates synchronizing the input/output adapter with the secondary input/output adapter using correlation data selected from at least one of a previously mirrored status and a synchronization in progress status.

21. The input/output adapter of claim 12, wherein the input/output adapter comprises part of a clustered computer system.

22. A dual input/output adapter system, comprising:
a primary adapter comprising a resident write cache;
a secondary adapter comprising a resident write cache; and
program code executable by each of the primary and secondary adapters configured to commingle data originating from both the primary and secondary adapters within each write cache of the respective adapters.

23. The system of claim 22, wherein each resident write cache further includes at least one of a cache directory and a data cache.

24. The system of claim 22, wherein the program code initiates allocating storage space in at least one of the write caches in response to detecting a de-staging occurrence.

25. The system of claim 22, wherein the program code initiates retrievably mapping the commingled data within the respective cache directory of each write cache.

26. A program product, comprising:
program code executable by an input/output adapter, wherein the program code is configured to commingle primary and backup data within the memory of a write cache resident in the input/output adapter; and
a signal bearing medium bearing the program code.

27. The program product of claim 26, wherein the signal bearing medium includes at least one of a recordable medium and a transmission-type medium.
